(19) United States
(12) Patent Application Publication
(10) Pub. No.: US 2017/0094084 A1
(43) Pub. Date: Mar. 30, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Hajime FUKASAWA, Kanagawa (JP)

(73) Assignee: FUJI XEROX CO., LTD., Tokyo (JP)

(21) Appl. No.: 15/058,882

(22) Filed: Mar. 2, 2016

(30) Foreign Application Priority Data
Sep. 24, 2015 (JP) 2015-187229

(51) Int. Cl. H04N 1/00

(52) U.S. Cl. CPC H04N 1/00458; H04N 1/00721; H04N 1/00771; H04N 2201/0089; H04N 2201/0082

(57) ABSTRACT

An information processing apparatus includes an acquisition unit and a display controller. The acquisition unit acquires a direction of an image relative to a placement section, the image being formed on a sheet which is transported to and placed on the placement section. The display controller performs control for displaying a first image on a display, the first image representing an external appearance obtained when the sheet which is placed on the placement section and on which the image is formed is viewed from a specific direction relative to the placement section, and causes, in a case where the direction which is predetermined for the image is acquired, a second image which represents an external appearance of the sheet obtained when viewed from a direction different from the predetermined direction to be displayed.

### CROSS-REFERENCE TO RELATED APPLICATIONS

This application is based on and claims priority under 35 USC 119 from Japanese Patent Application No. 2015-187229 filed Sep. 24, 2015.

### BACKGROUND

(i) Technical Field

The present invention relates to an information processing apparatus, an information processing method, and a non-transitory computer readable medium.

(ii) Related Art

There have been techniques for easily understanding an image formed on a sheet.

### SUMMARY

According to an aspect of the invention, there is provided an information processing apparatus including an acquisition unit and a display controller. The acquisition unit acquires a direction of an image relative to a placement section, the image being formed on a sheet which is transported to and placed on the placement section. The display controller performs control for displaying a first image on a display, the first image representing an external appearance obtained when the sheet which is placed on the placement section and on which the image is formed is viewed from a specific direction relative to the placement section, and causes, in a case where the direction which is predetermined for the image is acquired, a second image which represents an external appearance of the sheet obtained when viewed from a direction different from the predetermined direction to be displayed.

### BRIEF DESCRIPTION OF THE DRAWINGS

Exemplary embodiments of the present invention will be described in detail based on the following figures, wherein:

FIGS. 1A and 1B are diagrams illustrating the entire configuration of an image forming system according to a first exemplary embodiment;

FIG. 2 is a diagram illustrating a hardware configuration of a sheet supply apparatus, an image forming apparatus, and a post-processing apparatus;

FIG. 3 is a diagram illustrating a configuration of a post-processing apparatus;

FIGS. 4A and 4B are diagrams illustrating an external storing part on an enlarged scale;

FIGS. 5A and 5B are diagrams illustrating an internal storing part on an enlarged scale;

FIG. 6 is a diagram illustrating a hardware configuration of a UI apparatus;

FIGS. 7A and 7B are diagrams illustrating an example of displayed sheet images;

FIG. 8 is a diagram illustrating a functional configuration of a UI apparatus;

FIGS. 9A and 9B are diagrams illustrating an example of a first direction and a second direction;

FIGS. 10A and 10B are diagrams illustrating a relationship between a sheet image and an external appearance of the actual sheet for single-sided printing;

FIGS. 11A and 11B are diagrams illustrating a relationship between a sheet image and an external appearance of the actual sheet for double-sided printing;

FIG. 12 is a diagram illustrating an example of an operation procedure of a process for displaying a sheet image;

FIGS. 13A, 13B, 13C, and 13D are diagrams for explaining the direction of an image according to a second exemplary embodiment;

FIGS. 14A, 14B, and 14C are diagrams illustrating an example of a second sheet image displayed in an exemplary embodiment;

FIGS. 15A and 15B are diagrams for explaining the direction of an image according to a modification;

FIGS. 16A and 16B are diagrams for explaining the direction of an image according to a modification;

FIGS. 17A and 17B are diagrams for explaining another second direction according to a modification;

FIGS. 18A, 18B, 18C, 18D, 18E, and 18F are diagrams illustrating an example of an animation in which the external appearance of a sheet changes;

FIG. 19 is a diagram illustrating an example of a sheet image according to a modification;

FIGS. 20A, 20B, and 20C are diagrams illustrating an example of an animation according to a modification;

FIGS. 21A and 21B are diagrams illustrating an example of a sheet image according to a modification; and

FIGS. 22A and 22B are diagrams illustrating an example of a sheet image according to a modification.

### DETAILED DESCRIPTION

### [1] First Exemplary Embodiment

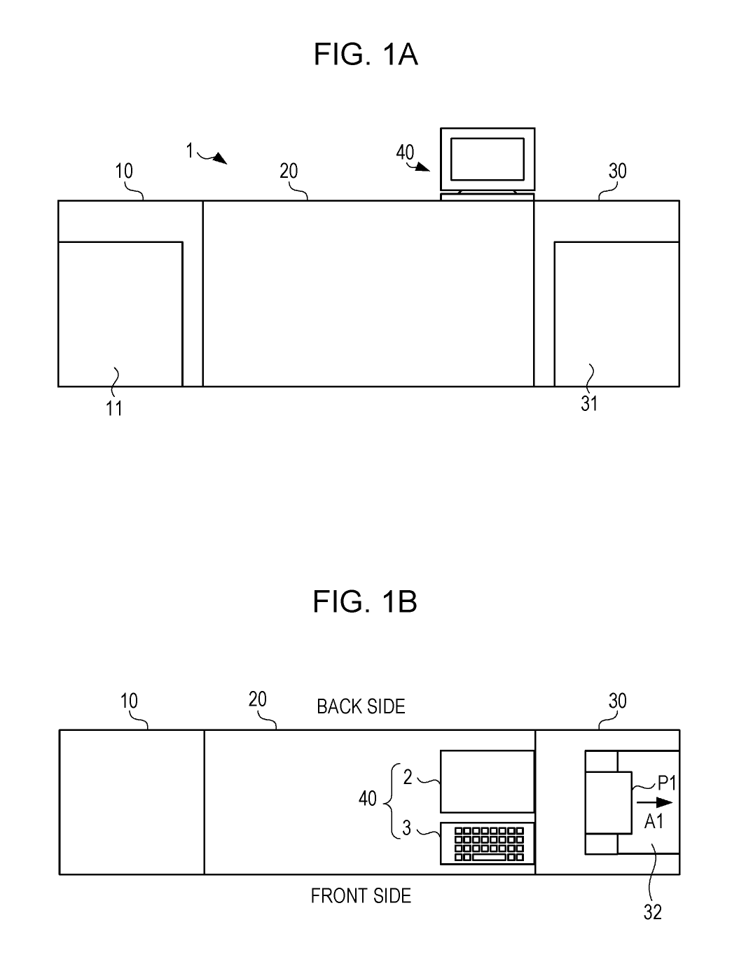

FIGS. 1A and 1B illustrate an external appearance of an image forming system 1 according to a first exemplary embodiment. FIG. 1A illustrates the image forming system 1 when viewed in a horizontal direction. FIG. 1B illustrates the image forming system 1 when viewed from perpendicularly above. The image forming system 1 is a system for forming images on a large number of sheets at high speed. The image forming system 1 includes a sheet supply apparatus 10, an image forming apparatus 20, a post-processing apparatus 30, and a user interface (UI) apparatus 40. The above apparatuses are connected to one another via communication lines (not illustrated in FIGS. 1A and 1B) and exchange data via the communication lines.

The sheet supply apparatus 10 accommodates sheets such as A4 paper, and supplies the sheet to the image forming apparatus 20. The sheet supply apparatus 10 has an opening/closing door 11. A user opens the opening/closing door 11 to place sheets. The image forming apparatus 20 forms an image on a sheet supplied from the sheet supply apparatus 10, and transports the sheet to the post-processing apparatus 30.

The post-processing apparatus 30 is an apparatus for performing post-processing such as sorting and stapling on the sheet transported from the image forming apparatus 20, and stores post-processed sheets (post-processing is not necessary, and therefore some sheets may not be post-processed). The post-processing apparatus 30 has an opening/closing door 31. A user opens the opening/closing door 31 to take the stored sheets out of the post-processing apparatus 30. Furthermore, the post-processing apparatus 30 includes an external storing part 32 which stores sheets outside the post-processing apparatus 30.

A sheet P1 is transported in a transport direction A1 and stored in the external storing part 32. In the image forming system 1, the transport direction A1 in the external storing part 32 is a direction from the image forming apparatus 20 to the post-processing apparatus 30. A surface of the sheet P1 stored in the external storing part 32 that may be seen by a user in the stored state is referred to as a front surface, and a surface that may not be seen by the user is referred to as a rear surface.

The UI apparatus 40 includes a housing 2 which has a display surface on which an image is displayed and an operator 3 which receives a user operation. The UI apparatus 40 is used as a user interface for a user who uses the image forming system 1. A front side and a back side of the image forming system 1 for a user who uses the image forming system 1 are defined. In this exemplary embodiment, a side on which the opening/closing doors 11 and 31 are provided is defined as the front side. In order that a user who stands on the front side of the image forming system 1 is able to use the UI apparatus 40, the UI apparatus 40 is installed such that the display surface of the housing 2 is directed to the front side and the operator 3 is located nearer to the front side than the housing 2.

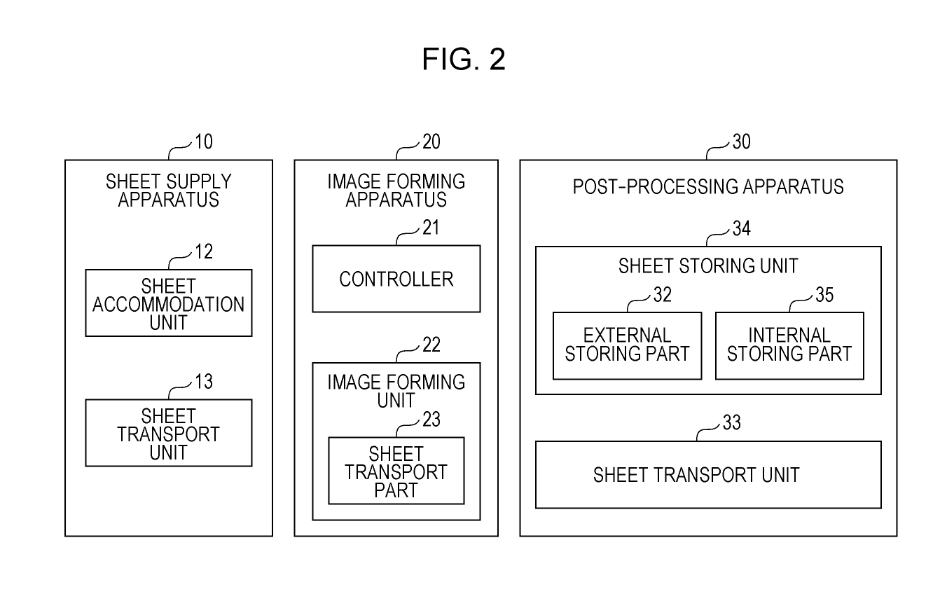

FIG. 2 illustrates a hardware configuration of the sheet supply apparatus 10, the image forming apparatus 20, and the post-processing apparatus 30. The sheet supply apparatus 10 includes a sheet accommodation unit 12 and a sheet transport unit 13. The sheet accommodation unit 12 is a so-called tray which accommodates sheets. The sheet transport unit 13 includes a roller and transports sheets accommodated within the sheet accommodation unit 12 to the image forming apparatus 20.

The image forming apparatus 20 includes a controller 21 and an image forming unit 22. The controller 21 converts image data transmitted from, for example, an external apparatus, which is not illustrated in FIG. 2, into a format to be processed by the image forming unit 22, and instructs the image forming unit 22 to form an image represented by the image data on a sheet. The controller 21 also instructs the image forming unit 22 to reflect various settings for forming the image on the sheet.

The controller 21 issues, for example, an instruction as to whether an image is to be formed on both sides or a single side of a sheet (double-sided printing or single-sided printing), based on setting of double-sided printing. Furthermore, the controller 21 issues an instruction as to whether an image is to be formed on a front surface or a rear surface, based on setting of a surface on which an image is formed (image formation surface). For example, in a case where single-sided printing is set, the controller 21 issues an instruction as to whether an image is to be formed on a front surface or a rear surface. Furthermore, in a case where double-sided printing is set, the controller 21 issues an instruction as to whether an image to be formed earlier (for example, an image of a smaller page number for a document image) is to be formed on a front surface or a rear surface. Forming an image for single-sided printing or an image formed earlier in double-sided printing on a front surface is referred to as face-up, and forming such an image on a rear surface is referred to as face-down.

The image forming unit 22 forms an image designated by the controller 21 on a sheet transported from the sheet supply apparatus 10, while reflecting designated settings (setting as to whether an image is to be formed on both sides or a single side, and as to whether the image is to be formed on a front surface or a rear surface for single-sided printing). The image forming unit 22 includes a sheet transport part 23. The sheet transport part 23 transports a sheet on which an image is formed to the post-processing apparatus 30.

The post-processing apparatus 30 includes a sheet transport unit 33 and a sheet storing unit 34. The sheet transport unit 33 transports a sheet transported from the image forming apparatus 20 to the sheet storing unit 34. The sheet storing unit 34 stores a stack of sheets transported by the sheet transport unit 33. The sheet storing unit 34 includes the external storing part 32, which is illustrated in FIG. 1B, and an internal storing part 35. The internal storing part 35 stores sheets within the post-processing apparatus 30.

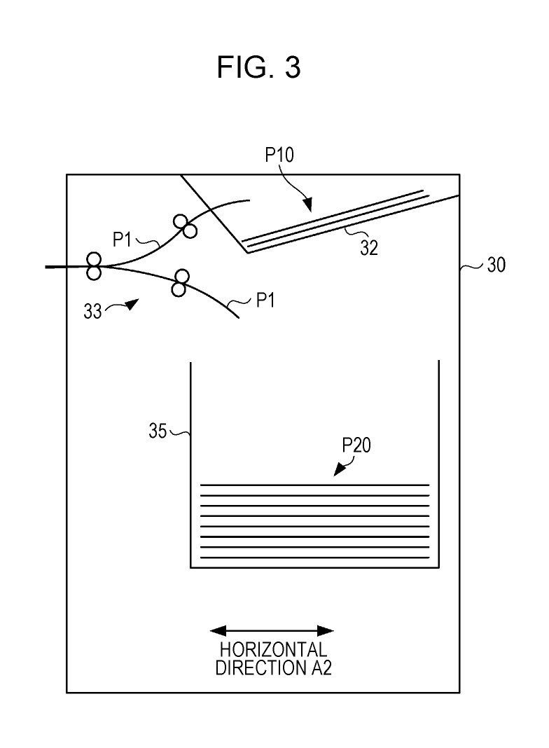

FIG. 3 illustrates a configuration of the post-processing apparatus 30. FIG. 3 illustrates the post-processing apparatus 30 when viewed from the front side illustrated in FIG. 1. The sheet transport unit 33 of the post-processing apparatus 30 forms a transport path through which a sheet P1 is transported to the external storing part 32 and a transport path through which a sheet P1 is transported to the internal storing part 35. In FIG. 3, a sheet group P10 which is stored in a stack in the external storing part 32 and a sheet group P20 which is stored in a stack in the internal storing part 35 are illustrated. The sheet group P10 is stored in a state in which surfaces of each sheet of the sheet group P10 are positioned diagonally relative to a horizontal direction A2, and the sheet group P20 is stored in a state in which surfaces of each sheet of the sheet group P20 are positioned along the horizontal direction A2.

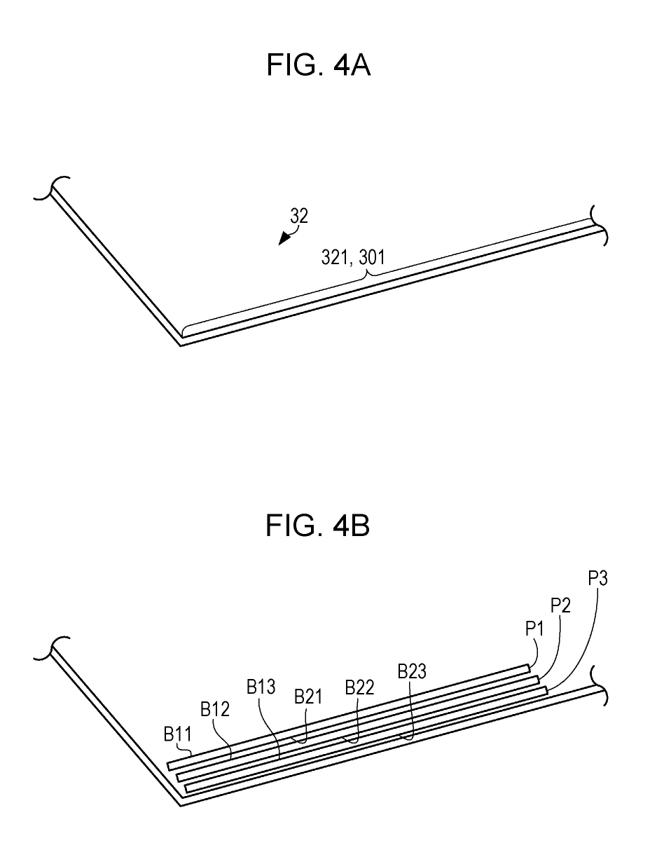

FIGS. 4A and 4B illustrate the external storing part 32 on an enlarged scale. FIG. 4A illustrates a placement section 321, which is a section of the external storing part 32 on which sheets may be placed. FIG. 4B illustrates a state in which sheets P1, P2, and P3 are placed on the placement section 321. The sheet P1 has a front surface B11 which may be seen by a user and a rear surface B21 which may not be seen by the user. The front surface B11 is a surface of the sheet P1 that faces opposite the placement section 321. Furthermore, the rear surface B21 is a surface of the sheet P1 that faces the placement section 321.

Similarly, the sheet P2 has a front surface B12 and a rear surface B22, and the sheet P3 has a front surface B13 and a rear surface B23. In the state illustrated in FIG. 4B, the sheet P1 is placed above the sheet P2 and the sheet P3, and therefore the sheet P2 and the sheet P3 may not be seen by a user. When the sheet P2 or the sheet P3 is placed on the top layer, the front surface may be seen by the user. Furthermore, the front surfaces B12 and B13 are, like the front surface B11, surfaces that face opposite the placement section 321, and the rear surfaces B22 and B23 are, like the rear surface B21, surfaces that face the placement section 321.

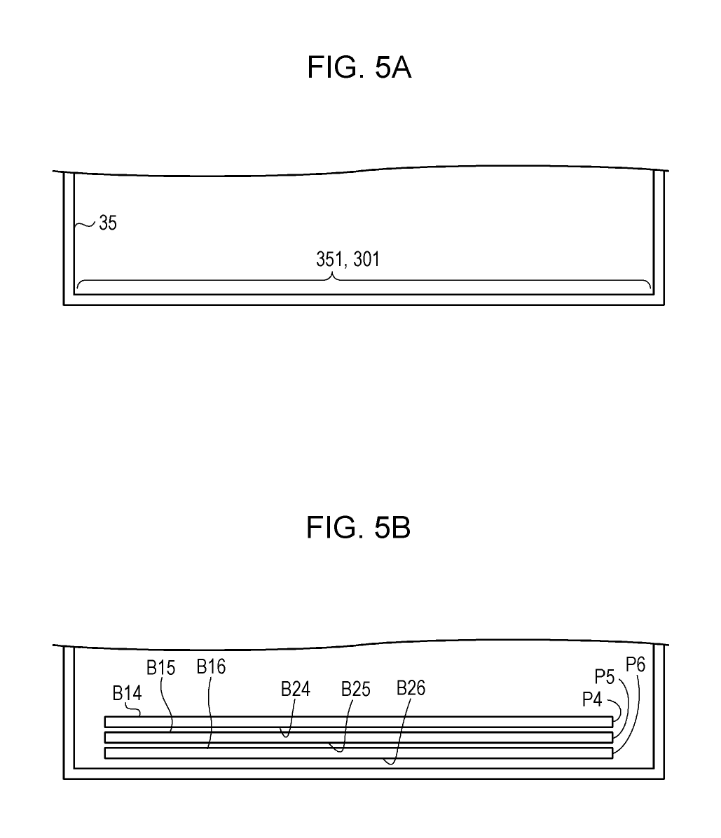

FIGS. 5A and 5B illustrate the internal storing part 35 on an enlarged scale. FIG. 5A illustrates a placement section 351, which is a section of the internal storing part 35 on which sheets may be placed. FIG. 5B illustrates a state in which sheets P4, P5, and P6 are placed on the placement section 351. The sheets P4, P5, and P6 also have front surfaces B14, B15, and B16 that face opposite the placement section 351 and rear surfaces B24, B25, and B26 that face the placement section 351, respectively. Hereinafter, the placement sections 321 and 351 will be referred to as a placement section 301 when they are not distinguished from each other.

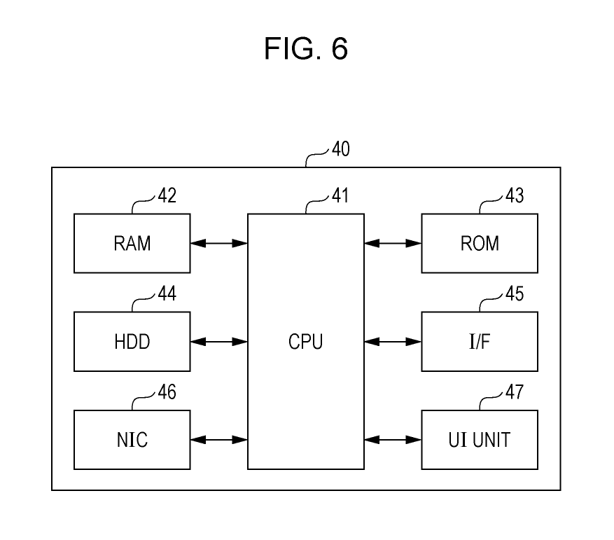

FIG. 6 illustrates a hardware configuration of the UI apparatus 40. The UI apparatus 40 is a computer which includes a central processing unit (CPU) 41, a random access memory (RAM) 42, a read only memory (ROM) 43, a hard disk drive (HDD) 44, an interface (I/F) 45, a network interface card (NIC) 46, and a UI unit 47. The CPU 41 controls operation of each unit by using the RAM 42 as a work area and executing a program stored in the ROM 43 or the HDD 44.

The HDD 44 stores data and a program to be used for control by the CPU 41. The I/F 45 is an interface to be used for exchange of data with the sheet supply apparatus 10, the image forming apparatus 20, and the post-processing apparatus 30. The NIC 46 includes a communication circuit, and performs communication with an external apparatus via a communication line, which is not illustrated in FIG. 6. The UI unit 47 includes a display and an operator such as a keyboard and a touch panel which is superimposed on a display surface of the display. The UI unit 47 displays an image and receives a user operation. The UI unit 47 is an example of a display according to an exemplary embodiment.

When an image is formed on a sheet, the UI apparatus 40 displays a sheet image which represents the sheet on which the image is formed on the UI unit 47.

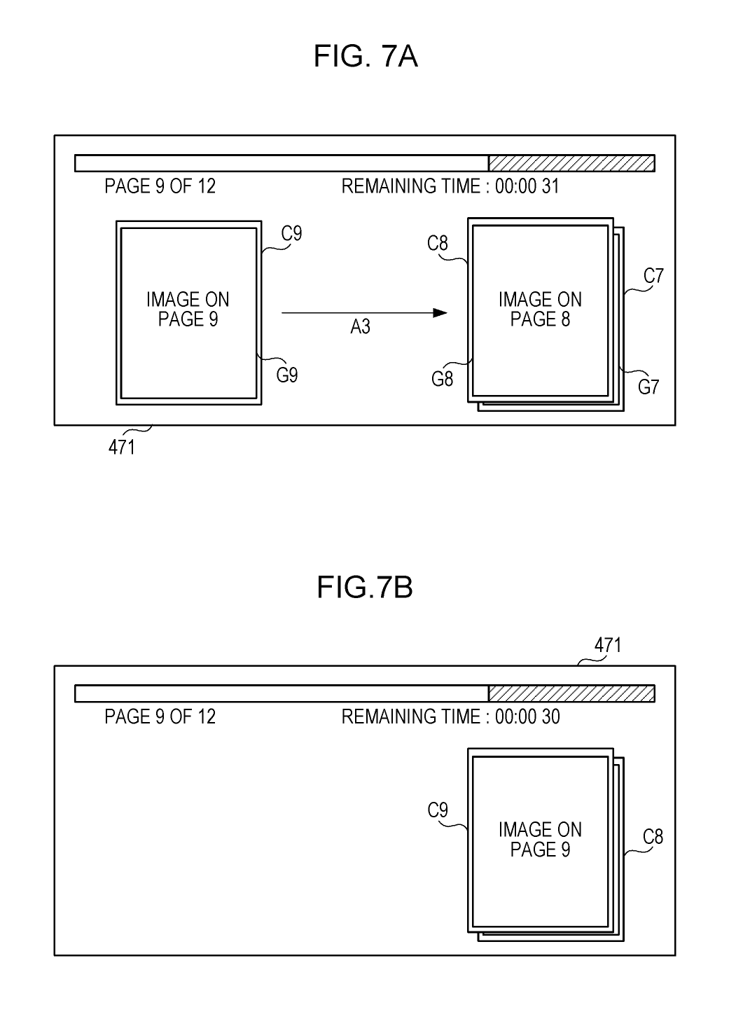

FIGS. 7A and 7B illustrate an example of displayed sheet images. In FIG. 7A, a sheet image C9 which represents a sheet on which an image G9 on the ninth page of images of twelve pages is formed is displayed on a display surface 471 of the UI unit 47. The sheet image C9 is displayed on a left part of the display surface 471. On a right part of the display surface 471, a sheet image C7 which represents a sheet on which an image G7 on the seventh page is formed, and a sheet image C8 which is superimposed on the image C7 and represents a sheet on which an image G8 on the eighth page is formed, are displayed.

The sheet image C9 moves in a direction of an arrow A3 illustrated in FIG. 7A, and is displayed superimposed on the sheet image C8, as illustrated in FIG. 7B. As described above, the UI apparatus 40 displays a state in which sheets on which images are formed are stacked on the placement section 301 of the sheet storing unit 34. When the CPU 41 of the UI apparatus 40 executes a program, a function for displaying sheet images as illustrated in FIGS. 7A and 7B is implemented.

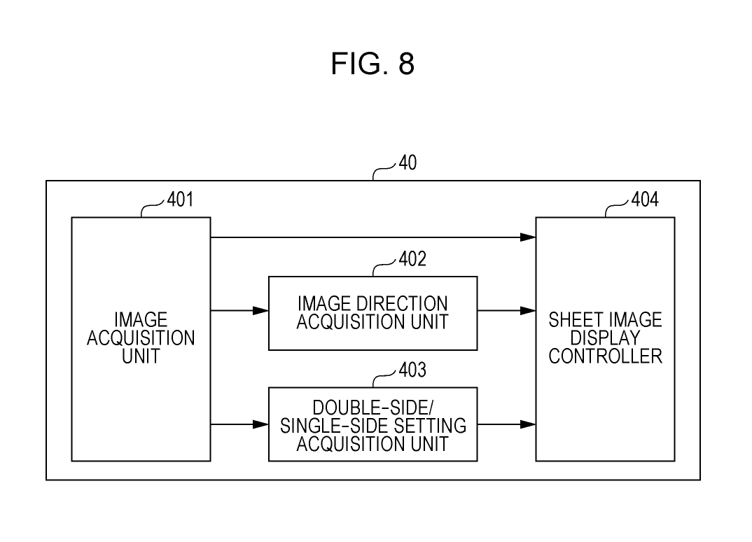

FIG. 8 illustrates a functional configuration of the UI apparatus 40. The UI apparatus 40 includes an image acquisition unit 401, an image direction acquisition unit 402, a double-side/single-side setting acquisition unit 403, and a sheet image display controller 404.

The image acquisition unit 401 acquires an image to be formed on a sheet placed on the placement section 301. For example, the controller 21 illustrated in FIG. 2 transmits image data which represents an image that the image forming unit 22 is instructed to form on a sheet, identification information for identifying the image (for example, the file name of the image) being added to the image, to the UI apparatus 40. The transmitted image data is supplied to the image acquisition unit 401, and the image acquisition unit 401 acquires the image represented by, the supplied image data as an image to be formed on the sheet. The image acquisition unit 401 supplies the acquired image and the identification information which identifies the image to the sheet image display controller 404, and supplies the identification information to the image direction acquisition unit 402 and the double-side/single-side setting acquisition unit 403.

The image direction acquisition unit 402 acquires the direction of the image which is formed on the sheet transported by the sheet transport unit 33 and placed on the placement section 301, the direction being relative to the placement section 301. The image direction acquisition unit 402 is an example of an acquisition unit according to an exemplary embodiment. In the first exemplary embodiment, the image direction acquisition unit 402 acquires a direction in which an image formed on a sheet faces the placement section 301 or a direction in which an image formed on a sheet faces opposite the placement section 301. The former represents the direction of an image formed on the front surface, and will be referred to as a “front direction”. The latter represents the direction of an image formed on the rear surface, and will be referred to as a “rear direction”.

The image direction acquisition unit 402 requires the controller 21 illustrated in FIG. 2 to set the above-mentioned image formation surface for an image identified by identification information supplied from the image acquisition unit 401, and acquires the setting for the image formation surface which is transmitted in response to the request. For example, in the case where the setting for the image formation surface acquired when an image is to be formed on a single side is face-up (setting for forming an image on a front surface), the image direction acquisition unit 402 acquires the “front direction, and in the case where the setting for the image formation surface is face-down (setting for forming an image on a rear surface), the image direction acquisition unit 402 acquires the “rear direction”.

Furthermore, in the case where the setting for the image formation surface acquired when an image is to be formed on both sides is face-up (setting for forming an image A to be formed earlier on a front surface), the image direction acquisition unit 402 acquires the “front direction” as the direction of the image A, and in the case where the setting for the image formation surface is face-down (setting for forming the image A to be formed earlier on the rear surface), the image direction acquisition unit 402 acquires the “rear direction” as the direction of the image A. The image direction acquisition unit 402 supplies the acquired direction of the image in association with the identification information of the image to the sheet image display controller 404.

The double-side/single-side setting acquisition unit 403 acquires setting representing whether an image is formed on both sides or a single side of a sheet. The double-side/single-side setting acquisition unit 403 requires the controller 21 to perform setting for double-sided printing for an image identified by identification information supplied from the image acquisition unit 401. The double-side/single-side setting acquisition unit 403 acquires the setting for double-sided printing (either double-sided printing or single-sided printing) transmitted in response to the request, and supplies the setting in association with the identification information used for acquisition of the setting to the sheet image display controller 404.

The sheet image display controller 404 performs control for displaying a sheet image which represents the external appearance of a sheet on which an image is formed on the UI unit 47. The sheet image display controller 404 is an example of a “display controller” according to an exemplary embodiment. The sheet image display controller 404 causes a sheet image such as the sheet image C8 or C9 illustrated in FIG. 7A to be displayed, by using an image supplied from the image acquisition unit 401. For example, the sheet image display controller 404 causes the image C9 illustrated in FIG. 7A to be displayed at a timing at which an image on the ninth page is formed on a sheet, and controls display such that the state illustrated in FIG. 7B in which the sheet image C9 is superimposed on the sheet image C8 is obtained at a timing at which the sheet is transported.

The sheet image display controller 404 causes the two types of sheet image to be displayed, as described below. The sheet image display controller 404 causes a sheet image representing an external appearance obtained when a sheet on which an image is formed and which is placed on the placement section 301 is viewed from a specific direction relative to the placement section 301 (this image will be referred to as a “first sheet image”) to be displayed. Furthermore, the sheet image display controller 404 causes a sheet image representing an external appearance obtained when the sheet is viewed from a direction different from the specific direction relative to the placement section 301 (this image will be referred to as a “second sheet image”) to be displayed. The first sheet image is an example of a “first image” according to an exemplary embodiment, and the second sheet image is an example of a “second image” according to an exemplary embodiment. Hereinafter, the specific direction relative to the placement section 301 will be referred to as a “first direction”, and the direction different from the first direction relative to the placement section 301 will be referred to as a “second direction”.

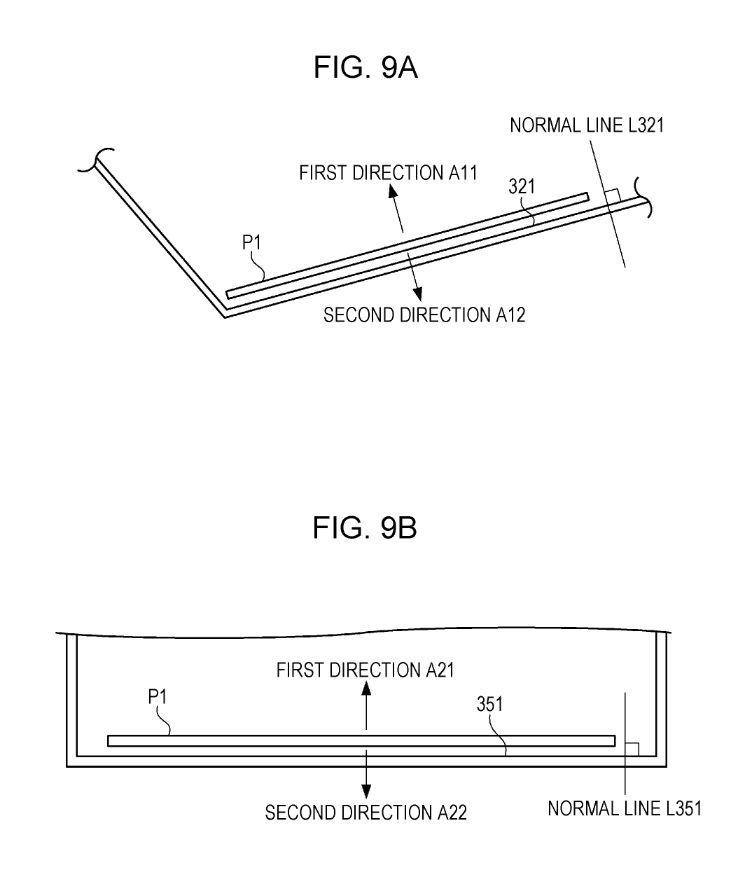

FIGS. 9A and 9B illustrate an example of the first direction and the second direction. In FIG. 9A, a first direction A11 and a second direction A12 for the case where the sheet P1 is placed on the placement section 321 are illustrated. The placement section 321 is flat. The first direction A11 is a direction that the placement section 321 is directed along a normal line L321 of the placement section 321, and the second direction A12 is a direction that faces the placement section 321 along the normal line L321.

In FIG. 9B, a first direction A21 and a second direction A22 for the case where the sheet P1 is placed on the placement section 351 are illustrated. The placement section 351 is flat. The first direction A21 is a direction that the placement section 351 is directed along a normal line L351 of the placement section 351, and the second direction A22 is a direction that the placement section 351 faces along the normal line L351. As described above, in the first exemplary embodiment, the external appearance of a sheet obtained when viewed from the first direction (specific direction) is an external appearance of a sheet obtained when viewed from the front surface side, and the external appearance of the sheet obtained when viewed from the second direction (direction different from the specific direction) is an external appearance of the sheet obtained when viewed from the rear surface side.

The sheet image display controller 404 determines, based on the direction of an image supplied from the image direction acquisition unit 402 in association with identification information of an image formed on a sheet and setting for double-sided printing supplied from the double-side/single-side setting acquisition unit 403 in association with the identification information, whether the first sheet image or the second sheet image is to be displayed.

The sheet image display controller 404 causes the second sheet image to be displayed when the direction predetermined for an image is acquired, and causes the first sheet image to be displayed when a different direction is acquired. For example, when an image is to be formed on a single side of a sheet, the sheet image display controller 404 defines the direction in which the image faces the placement section 301, that is, the rear direction, as a predetermined direction.

Specifically, in the case where an image is formed on a single side of a sheet and the rear direction is acquired, the sheet image display controller 404 causes an image which represents the external appearance of the sheet obtained when viewed from the second direction (that is, the external appearance of the sheet obtained when viewed from the rear surface side) to be displayed as the second sheet image. Furthermore, in the case where an image is formed on a single side of a sheet and the front direction is acquired, the sheet image display controller 404 causes an image which represents the external appearance of the sheet obtained when viewed from the first direction (that is, the external appearance of the sheet obtained when viewed from the front surface side) to be displayed as the first sheet image.

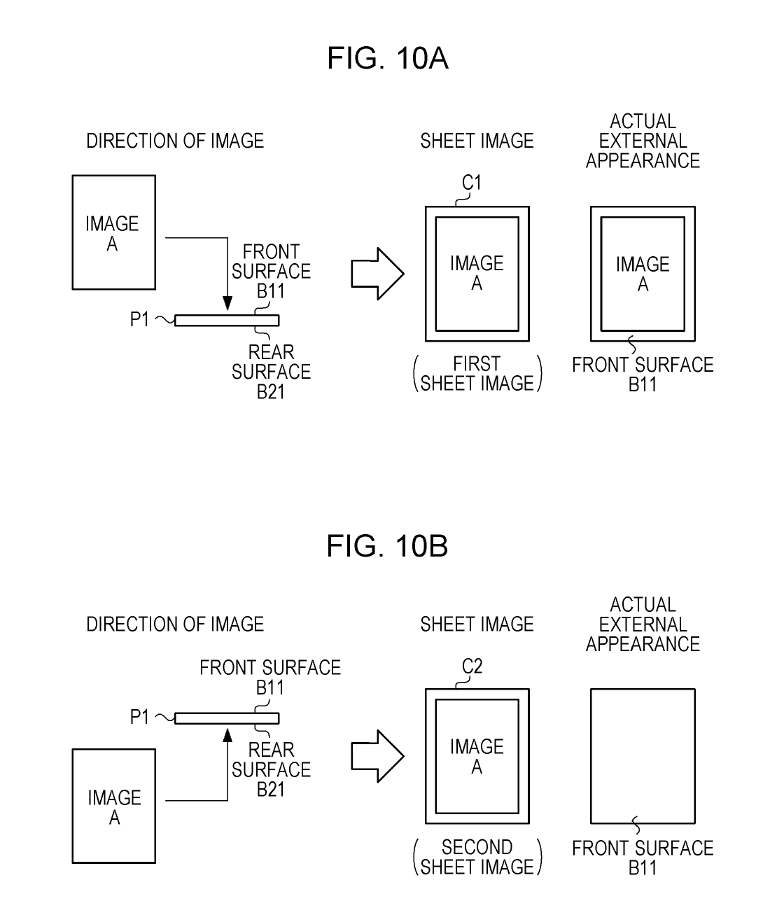

FIGS. 10A and 10B illustrate a relationship between a sheet image and the external appearance of the actual sheet for single-sided printing. In FIG. 10A, in the case where the image A is formed on the front surface B11 of the sheet P1 with setting of single-sided printing (that is, face-up is set), the sheet image C1 which represents an external appearance obtained when the sheet P1 is viewed from the first direction is displayed as the first sheet image. In this case, the actual external appearance of the sheet P1 which is placed on the placement section 301 is an external appearance in which the image A is formed on the front surface B11, like the sheet image C1.

In FIG. 10B, in the case where the image A is formed on the rear surface B21 of the sheet P1 with setting of single-sided printing (that is, face-down is set), the sheet image C2 which represents an external appearance obtained when the sheet P1 is viewed from the second direction is displayed as the second sheet image. In this case, the actual external appearance of the sheet P1 which is placed on the placement section 301 is an external appearance in which the front surface B11 is a blank sheet, unlike the sheet image C2.

Furthermore, in the case where an image is formed on both sides of a sheet, the sheet image display controller 404 does not use a predetermined direction. In this case, the sheet image display controller 404 causes the first sheet image to be displayed by defining the direction in which the sheet is viewed from the direction opposite the placement section 301 as a specific direction, and does not cause an image representing the external appearance of the sheet obtained when viewed from the placement section 301 side to be displayed.

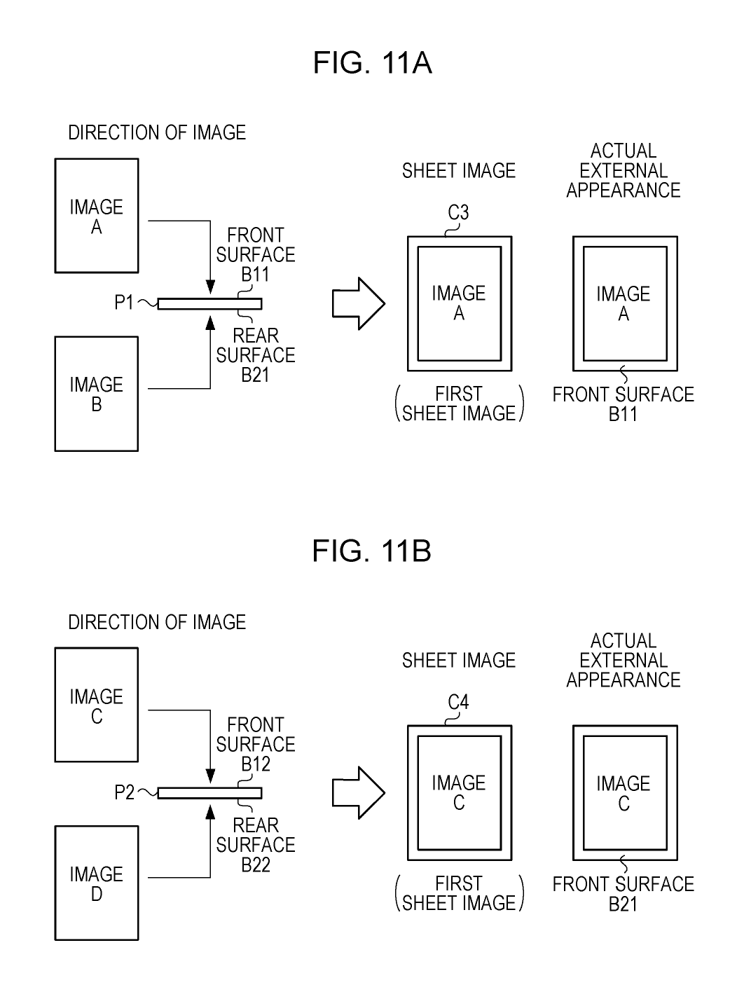

FIGS. 11A and 11B illustrate a relationship between a sheet image and an external appearance of the actual sheet for double-sided printing. In FIGS. 11A and 11B, the image A which is formed at first and the images B, C, and D which are then formed in order are illustrated. In FIG. 11A, in the case where the image A is formed on the front surface B11 of the sheet P1 and the image B is formed on the rear surface B21 with setting of double-sided printing and face-up, the sheet image C3 which represents an external appearance obtained when the sheet P1 is viewed from the first direction is displayed as the first sheet image. In this case, the actual external appearance of the sheet P1 which is placed on the placement section 301 is an external appearance in which the image A is formed on the front surface B11, like the sheet image C3.

After the images A and B are formed, in the case where the image C is formed on the front surface B12 of the sheet P2 and the image D is formed on the rear surface B22, the sheet image C4 which represents an external appearance obtained when the sheet P2 is viewed from the first direction is displayed as the first sheet image, as illustrated in FIG. 11B. In this case, the actual external appearance of the sheet P2 which is placed on the placement section 301 is an external appearance in which the image C is formed on the front surface B12, like the sheet image C4. Furthermore, the sheet image display controller 404 causes the sheet image C4 to be displayed after the sheet image C3 but does not cause sheet images which represent sheets on which the image B and the image D are formed to be displayed.

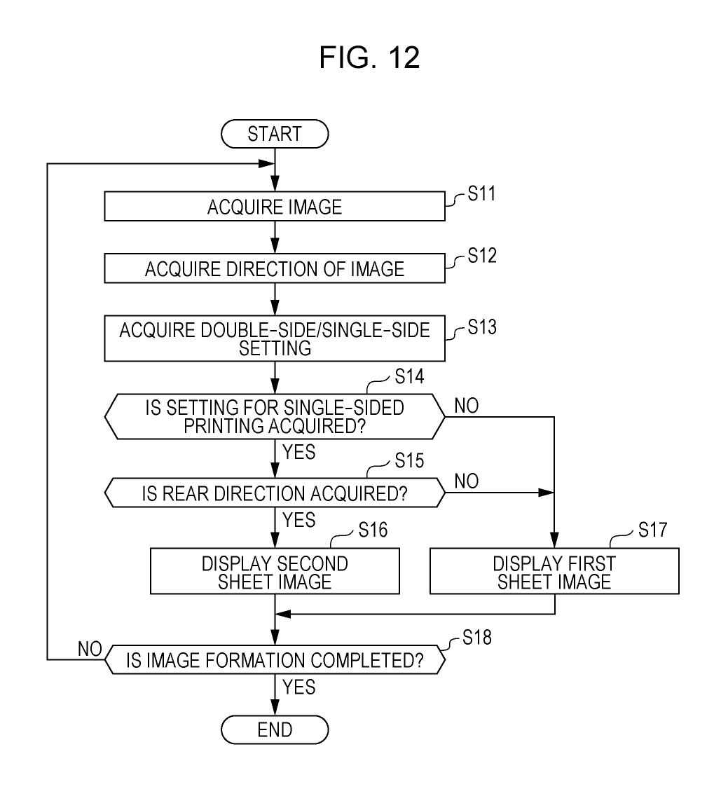

FIG. 12 illustrates an example of an operation procedure of a process for displaying a sheet image. This operation procedure is started when image formation on a sheet starts. The UI apparatus 40 (the image acquisition unit 401) first acquires an image to be formed on a sheet (step S11). Then, the UI apparatus 40 (the image direction acquisition unit 402) acquires the direction of the image to be formed on the sheet relative to the placement section 301 (step S12). Then, the UI apparatus 40 (the double-side/single-side setting acquisition unit 403) acquires setting of double-sided printing (step S13).

Next, the UI apparatus 40 (the sheet image display controller 404) determines whether or not setting of single-sided printing is acquired (step S14). When it is determined that the setting of single-sided printing is acquired (the determination result is YES), the UI apparatus 40 (the sheet image display controller 404) determines whether or not the rear direction (the direction that faces the placement section 301) is acquired as the direction of the image (step S15). When it is determined that the rear direction is acquired in step S15 (the determination result is YES), the UI apparatus 40 (the sheet image display controller 404) displays the second sheet image illustrated in FIG. 10B (step S16).

When it is determined that the setting of single-sided printing is not acquired (the determination result is NO) in step S14 or when it is determined that the rear direction is not acquired (the determination result is NO) in step S15, the UI apparatus 40 (the sheet image display controller 404) displays the first sheet image illustrated in FIG. 10A. After the processing of step S16 and step S17, the UI apparatus 40 determines whether or not image formation in the image forming system 1 is completed (step S18). When it is determined that the image formation is not completed (the determination result is NO), the UI apparatus 40 returns to step S11 to continue the operation. When it is determined that the image formation is completed (the determination result is YES), the UI apparatus 40 ends the operation procedure.

In the first exemplary embodiment, as explained with reference to FIGS. 10A and 10B and FIGS. 11A and 11B, by displaying a sheet image representing the external appearance of a sheet on which an image is formed, a user is able to easily understand that the displayed image is to be formed on the sheet, compared to the case where only an image to be formed on the sheet is displayed. Furthermore, in the case where single-sided printing and face-down are set, by displaying an image representing the external appearance of a sheet obtained when viewed from the second direction, an image to be formed on the sheet may be understood by a user, without displaying a sheet image of a blank sheet.

In other words, even in the case where an image is formed only on the rear surface of a sheet, the user is able to understand the image. Furthermore, in the case where an image is formed on both sides of a sheet, when a sheet image is displayed for both sides of the sheet, the number of sheet images displayed is larger than the number of sheets on which an image is formed. In the first exemplary embodiment, an image representing an external appearance obtained when the sheet is viewed from the rear surface is not displayed. Therefore, the number of sheet images is equal to the number of sheets, and the user is thus able to understand the number of sheets on which an image is formed.

### [2] Second Exemplary Embodiment

A second exemplary embodiment of the present invention will be described by focusing on differences from the first exemplary embodiment. In the first exemplary embodiment, the front direction and the rear direction are acquired as the direction of an image. However, in the second exemplary embodiment, in the case where the top and the bottom of an image to be formed on a sheet are defined, a direction that the upper part of the image is directed is acquired as the direction of the image.

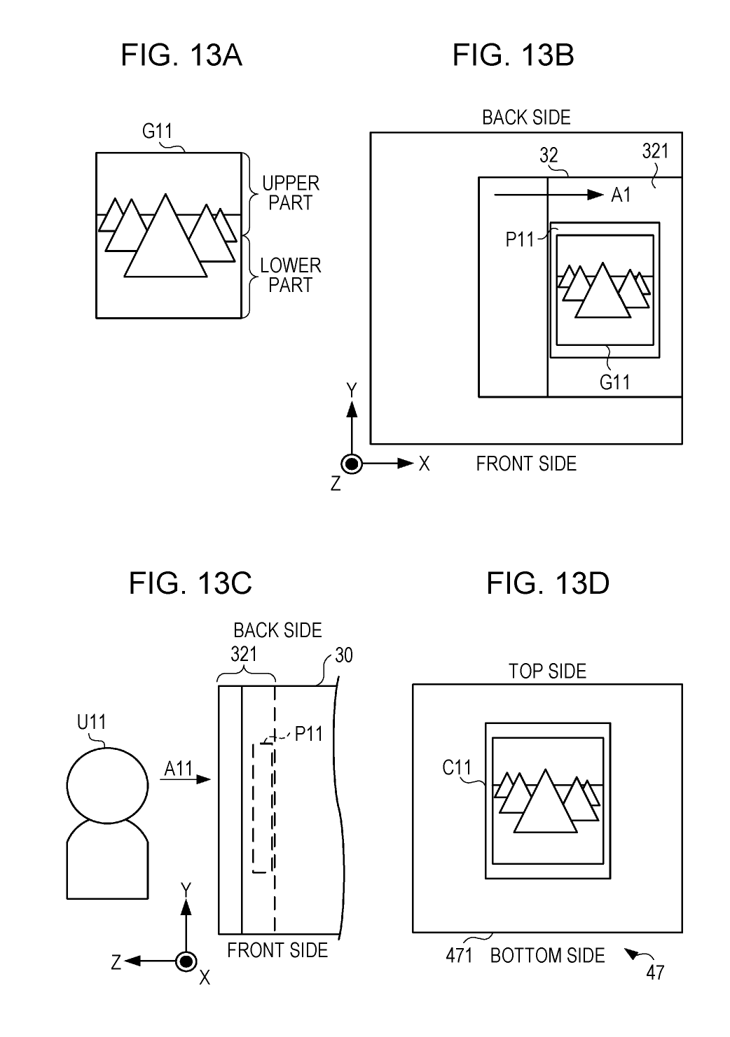

FIGS. 13A, 13B, 13C, and 13D are diagrams for explaining the direction of an image according to the second exemplary embodiment. In FIG. 13A, a photographic image G11 of a landscape is illustrated. In the image G11, normally, the sky is placed in an upper part and the ground is in a lower part. In FIG. 13B, a state in which a sheet P11 on which the image G11 is formed is transported in the transport direction A1 and is placed on the placement section 321 of the external storing part 32 is illustrated. As illustrated in FIG. 13B, the front side and the back side of the placement section 321 relative to a user are defined. In FIG. 13B, the sheet P11 is placed on the placement section 321 in the direction in which the upper part of the image G11 is directed to the back side of the placement section 321.

The sheet image display controller 404 causes the first sheet image to be displayed with the direction in which the top side of the display surface 471 of the UI unit 47 is the back side of the placement section 321 and the bottom side of the display surface 471 is the front side of the placement section 321 being defined as the first direction. In FIG. 13B, the direction along the transport direction A1 in which the sheet P11 is transported is represented as an X-axis direction, the direction from the front side to the back side of the placement section 321 is represented as a Y-axis direction, and the direction toward the perpendicular direction is represented as a Z-axis direction.

In FIG. 13C, the post-processing apparatus 30 viewed from the X-axis direction and a user U11 who views the placement section 321 of the post-processing apparatus 30 from the first direction are illustrated. The user U11 is directed to a direction A11 (perpendicularly downward direction) opposite the Z-axis direction with the head directed to the Y-axis direction. In the case where the first sheet image is displayed in the example of FIGS. 13A and 13B, the sheet image display controller 404 causes an image which represents the external appearance of the sheet P11 obtained when viewed by the user U11 to be displayed as the first sheet image. As described above, in the second exemplary embodiment, the external appearance of a sheet obtained when viewed from the first direction represents an external appearance obtained when a specific side of the sheet (a side on the back side when the sheet is placed on the placement section 321 in the example of FIGS. 13A and 13B) is placed on the top (overhead side for a person who views the sheet).

Specifically, the sheet image display controller 404 causes a part of the image G11 that is directed to the back side of the placement section 321, that is, the upper part of the image G11, to be displayed directed to the top side of the display surface 471, and a part of the image G11 that is directed to the front side of the placement section 321, that is, the lower part of the image G11, directed to the bottom side of the display surface 471. In FIG. 13D, the sheet image C11 of the sheet P11 displayed as described above is displayed on the display surface 471. That is, the sheet image display controller 404 causes the top and the bottom of an image to be displayed as the original image data on the display surface 471. The sheet image C11 represents the external appearance of a sheet obtained when a user who uses the image forming system 1 views the sheet from the front side of the placement section 321.

In the second exemplary embodiment, the controller 21 of the image forming apparatus 20 controls image formation in a normal mode in which an image is formed on a sheet based on the top and the bottom of the image of the original image data and a vertically inverted mode in which an image is formed on a sheet with the top and bottom of the image inverted. The image direction acquisition unit 402 requires the controller 21 to set the above mode. When setting for the normal mode is transmitted, the image direction acquisition unit 402 acquires a direction in which the upper part of the image to be formed on the sheet is directed to the back side of the placement section 321 (hereinafter, referred to as a “back side direction”). When setting for the vertically inverted mode is transmitted, the image direction acquisition unit 402 acquires a direction in which the upper part of the image to be formed on the sheet is directed to the front side of the placement section 321 (hereinafter, referred to as a “front side direction”).

In the case where the above-mentioned “back side direction” is acquired, the sheet image display controller 404 causes an image which represents the external appearance of the sheet P11 obtained when viewed from the above-mentioned first direction to be displayed as the first sheet image. In contrast, in the case where the above-mentioned “front side direction” is acquired, the sheet image display controller 404 causes an image which represents the external appearance of the sheet P11 obtained when viewed from the direction in which the upper part of the image is the top side of the display surface 471 (in this case, the second direction) to be displayed as the second sheet image.

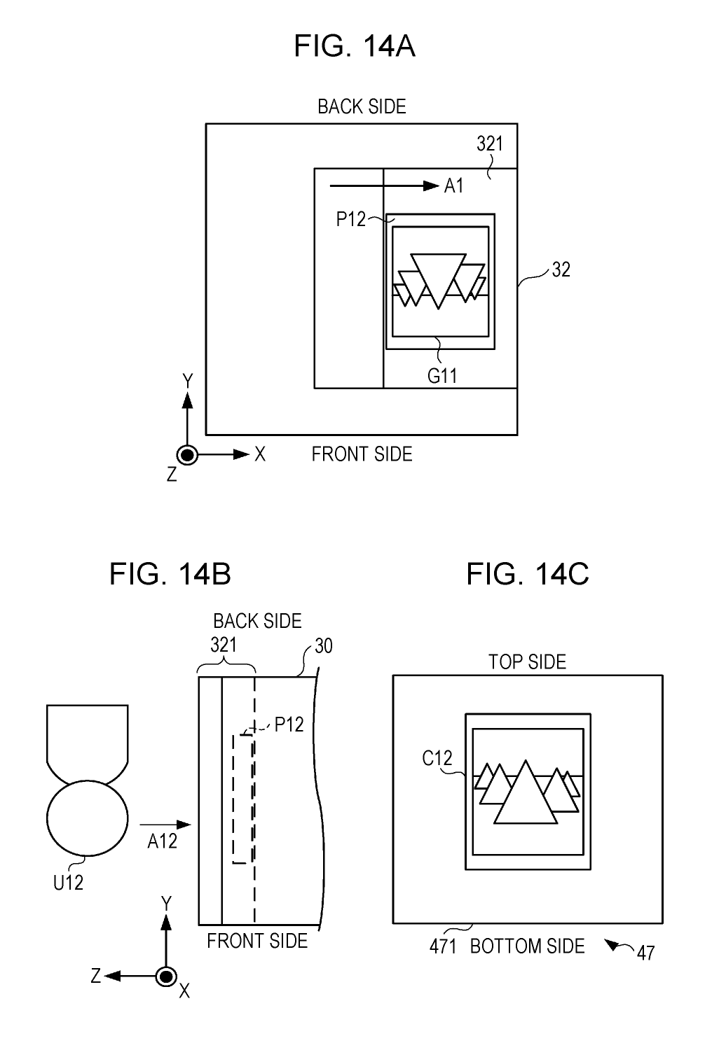

FIGS. 14A, 14B, and 14C illustrate an example of the second sheet image displayed in the second exemplary embodiment. In FIG. 14A, a state in which a sheet P12 on which the image G11 is formed is placed on the placement section 321 with the upper part of the image G11 being directed to the front side of the placement section 321 is illustrated. In FIG. 14B, the post-processing apparatus 30 viewed from the X-axis direction and a user U12 who views the placement section 321 of the post-processing apparatus 30 from the second direction is illustrated. The user U12 is directed to the direction A12 (perpendicularly downward direction) opposite the Z-axis direction with the head directed to the direction opposite the Y-axis direction, unlike the user U11 illustrated in FIG. 13C.

In the case where the second sheet image is displayed in the example of FIG. 14A, the sheet image display controller 404 causes an image which represents the external appearance of the sheet P12 viewed by the user U12 to be displayed as the second sheet image. As described above, in the second exemplary embodiment, similar to the external appearance of a sheet obtained when viewed from the above-mentioned first direction, the external appearance of the sheet obtained when viewed from the second direction represents an external appearance obtained when a specific side of the sheet (in the example of FIG. 14A, a side on the front side when the sheet is placed on the placement section 321) is placed on the top. Specifically, the sheet image display controller 404 causes the second sheet image to be displayed with a part of the image G11 that is directed to the front side of the placement section 321, that is, the upper part of the image G11, being directed to the top side of the display surface 471, and with a part of the image G11 that is directed to the back side of the placement section 321, that is, the lower part of the image G11, being directed to the bottom side of the display surface 471. This is the same as the case where the first sheet image is displayed in the example of FIGS. 13A to 13D.

That is, as illustrated in FIG. 14C, the sheet image display controller 404 causes a sheet image C12 which represents the top and the bottom of the image G11 of the original image data to be displayed as the second sheet image on the display surface 471. If an image (first sheet image) which represents the external appearance of a sheet obtained when viewed from the first direction is displayed when the “front side direction” is acquired, a photographic image of an upside down landscape is displayed on the display surface 471. In the second exemplary embodiment, by displaying the second sheet image viewed from the second direction illustrated in FIG. 14B when the “front side direction” is acquired, a user is able to easily understand an image formed on a sheet, compared to the case where the first sheet image is displayed in that case.

### [3] Modifications

Each of the foregoing exemplary embodiments is merely an example and may be modified as described below. Furthermore, each exemplary embodiment and each modification may be combined together as necessary.

### [3-1] Method for Acquiring Direction of Image

In the second exemplary embodiment, the direction of an image may be acquired in a different method. For example, it is assumed that the controller 21 of the image forming apparatus 20 forms an image by performing setting as to the direction of an image relative to a sheet (vertical direction and horizontal direction) and setting as to which one of a short side and a long side of a rectangular sheet is to be transported as a leading edge. Defining the short side of a sheet as a leading edge is referred to as short edge feed (SEF), and defining the long side as a leading edge is referred to as long edge feed (LEF).

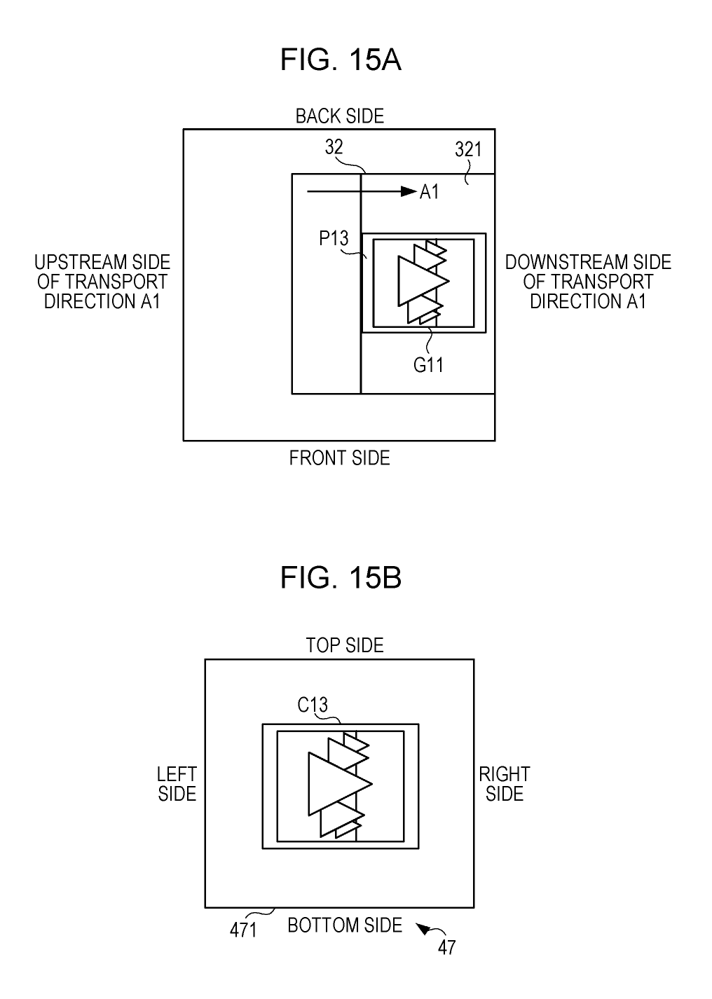

FIGS. 15A and 15B are diagrams for explaining the direction of an image according to a modification. In the case where the vertical direction and SEF are set, as illustrated in FIG. 15A, the upper part of the image G11 formed on a sheet P13 is directed to the downstream side of the transport direction A1 illustrated in FIGS. 1A and 1B. Furthermore, in the case where the horizontal direction and LEF are set, although the sheet is in the horizontal direction, the upper part of the image is directed to the downstream side of the transport direction A1, as in the case where the vertical direction and SEF are set. In contrast, in the case where the vertical direction and LEF are set or the horizontal direction and SEF are set, an image is formed with the upper part of the image G11 being directed to the front side of the placement section 321.

The image direction acquisition unit 402 requests the controller 21 for the above two settings. When setting of the vertical direction and SEF or setting of the horizontal direction and LEF is transmitted, the image direction acquisition unit 402 acquires the direction in which the upper part of an image to be formed on a sheet is directed to the downstream side of the transport direction A1 (hereinafter, referred to as a “downstream direction of the transport direction A1”). When setting of the vertical direction and LEF or setting of the horizontal direction and SEF is transmitted, the image direction acquisition unit 402 acquires the above front direction (direction in which the upper part of an image to be formed on a sheet is directed to the front side of the placement section 321).

In the case where the downstream direction of the transport direction A1 is acquired, the sheet image display controller 404 causes, for example, a sheet image which represents the external appearance of the sheet P13 obtained when viewed from the first direction to be displayed as the first sheet image. In FIG. 15B, the sheet image C13 displayed as described above is illustrated. The upper part of the image formed on the sheet represented by the sheet image C13 is directed to a right side or a left side of the display surface 471 of the UI unit 47 that corresponds to the downstream side of the transport direction A1 (in this example, the right side). The lower part of the image is directed to a right side or a left side of the display surface 471 that corresponds to the upstream side of the transport direction A1 (in this example, the left side).

### [3-2] Direction Along Transport Direction

Image formation may be performed such that the upper part of an image is directed to the upstream side of the transport direction A1.

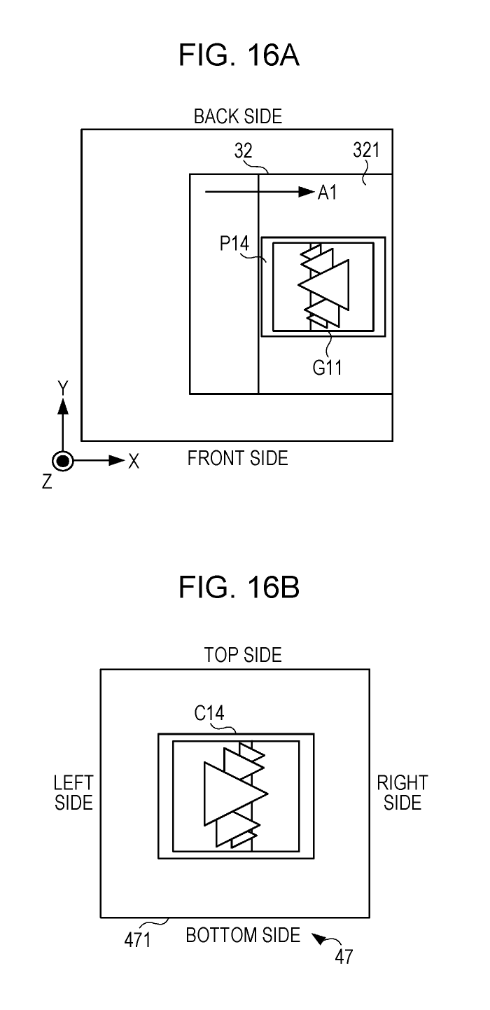

FIGS. 16A and 16B are diagrams for explaining the direction of an image according to a modification. In FIG. 16A, a state in which the upper part of the image G11 is directed to the downstream side of the transport direction A1 when the sheet P11 on which the image G11 illustrated in FIGS. 13A to 13D is formed is placed on the placement section 321 of the external storing part 32 is illustrated. In this case, the image direction acquisition unit 402 acquires a direction in which the upper part of the image formed on the sheet is directed to the upstream side of the transport direction A1 (hereinafter, referred to as the “upstream direction of the transport direction A1”).

In the case where the upstream direction of the transport direction A1 is acquired as the direction of an image, the sheet image display controller 404 causes, for example, an image which represents the external appearance of a sheet obtained when viewed from a direction in which the upper part of the display surface 471 of the UI unit 47 is the front side of the placement section 321 to be displayed as the second sheet image. In the case where the second sheet image is displayed in the example of FIG. 16A, the sheet image display controller 404 causes an image which represents the external appearance of a sheet P14 obtained when viewed by the user U12 illustrated in FIG. 14B (in this case, the eternal appearance of the sheet P14 obtained when viewed from the second direction) to be displayed as the second sheet image.

In FIG. 16B, a sheet image C14, which is the second sheet image displayed on the display surface 471 of the UI unit 47, is displayed as describe above. That is, the sheet image display controller 404 causes the sheet image C14 to be displayed with the part of the image G11 that is directed to the upstream side of the transport direction A1, that is, the upper part of the image G11, being directed to the right side of the display surface 471, and with the part of the image G11 that is directed to the downstream side of the image G11, that is, the lower part of the image G11, being directed to the left side of the display surface 471. This is the same as the case where the first sheet image is displayed in the example of FIGS. 15A and 15B.

As described above, in the example of FIGS. 16A and 16B, the direction of the top and the bottom of an image to be formed on a sheet is the same between the case where the first sheet image is displayed and the case where the second sheet image is displayed. In contrast, if the first sheet image is displayed in the case where the downstream direction of the transport direction A1 is acquired, the direction of the top and the bottom of the image differs between the case where the upstream direction of the transport direction A1 is acquired and the case where the downstream direction of the transport direction A1 is acquired. Compared to such a case, the direction of an image is the same in this modification. Therefore, a user is able to easily understand an image to be formed on a sheet.

In the case where the upstream direction of the transport direction A1 is acquired, the sheet image display controller 404 may cause an image which represents the external appearance of the sheet P14 obtained when viewed from the direction in which the upper part of the image G11 is the top side of the display surface 471 to be displayed as the second sheet image.

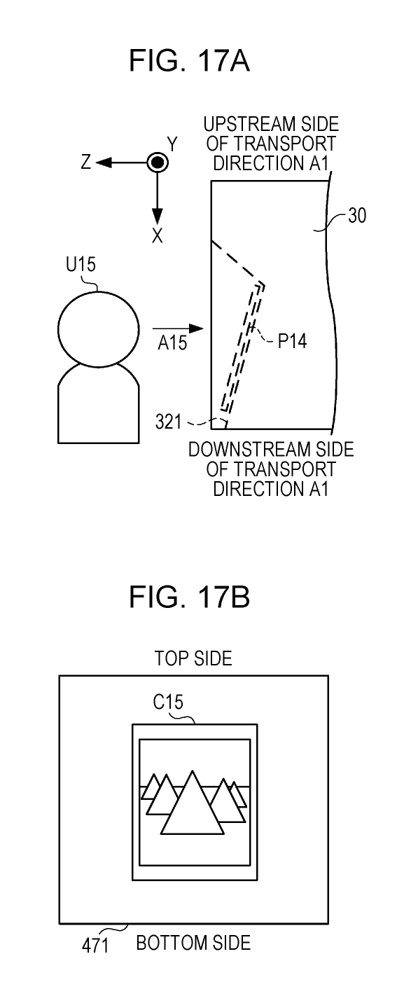

FIGS. 17A and 17B are diagrams for explaining another second direction according to a modification. In FIG. 17A, the post-processing apparatus 30 viewed from the Y-axis direction and a user U15 who views the placement section 321 of the post-processing apparatus 30 from the second direction are illustrated. The user U15 is directed to a direction A15 opposite the Z-axis direction with the head directed to the direction opposite the X-axis direction.

In the case where the second sheet image is displayed in the example of FIG. 16A, the sheet image display controller 404 causes an image which represents the external appearance of the sheet P14 obtained when viewed by the user U15 illustrated in FIG. 17B (the external appearance of the sheet P14 obtained when viewed from the second direction in this case) to be displayed as the second sheet image. That is, in this example, the external appearance of a sheet obtained when viewed from the second direction represents an external appearance obtained when a side of the sheet that is on the upstream side of the transport direction A1 when the sheet is placed on the placement section 321 is placed on the top. In FIG. 17B, a sheet image C15 displayed on the display surface 471 as described above is displayed. As described above, the sheet image display controller 404 causes the sheet image C15 to be displayed with the upper part of the image G11 being directed to the top side of the display surface 471 and with the lower part of the image G11 being directed to the bottom side of the display surface 471. Accordingly, the top and the bottom of an image displayed on a sheet image is equal to the top and the bottom of the actual image, and therefore a user is able to easily understand an image to be formed on a sheet.

### [3-3] Animation

In the case where, for example, the second sheet image C12 is caused to be displayed in the example illustrated in FIGS. 10A and 10B, the sheet image display controller 404 causes an animation in which an image changes from the external appearance of the sheet P1 represented by the second sheet image C12 into the external appearance of the sheet P1 obtained when viewed from the first direction (the actual external appearance illustrated in FIG. 10B in the example of FIGS. 10A and 10B) to be displayed.

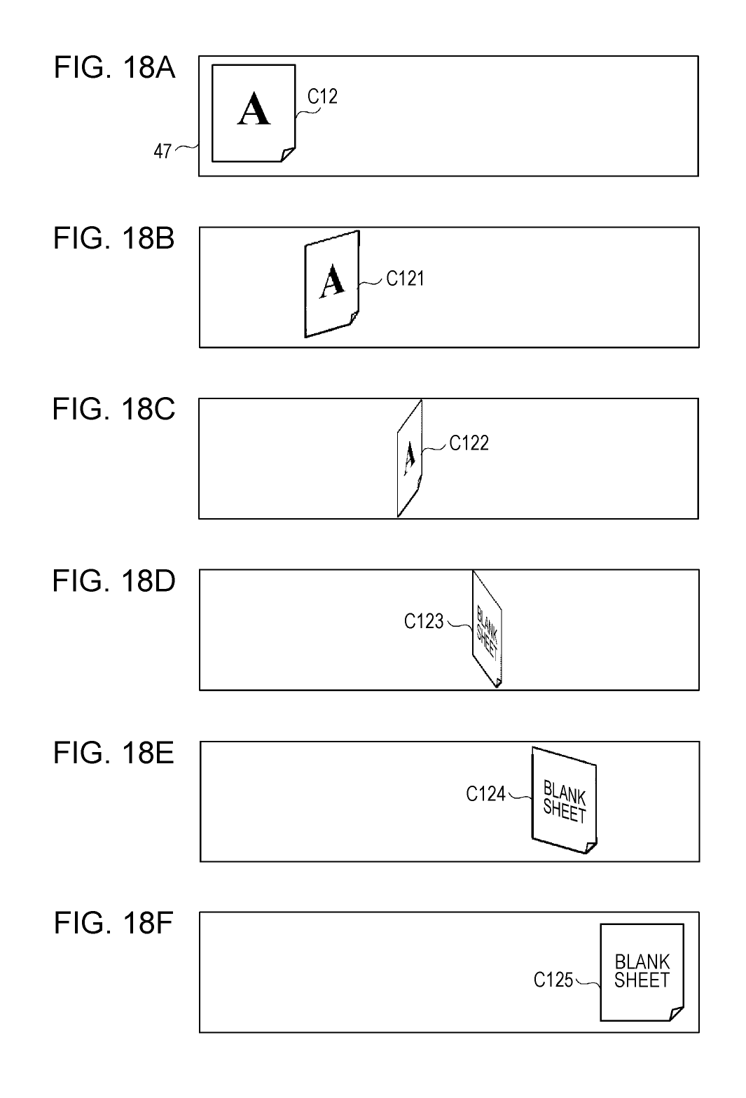

FIGS. 18A to 18F illustrate an example of an animation in which the external appearance of a sheet changes. In FIG. 18A, the sheet image C12 displayed on the UI unit 47 illustrated in FIG. 2 is illustrated. The sheet image C12 represents the rear surface of the sheet P1 on which the image G11 is formed. In FIGS. 18B, 18C, 18D, and 18E, images C121, C122, C123, and C124 representing a state in which the sheet P1 is gradually turned over from the rear surface to the front surface are illustrated. In FIG. 18F, the sheet P1 is completely turned over, and a sheet image C125 representing the external appearance of the sheet P1 obtained when viewed from the front surface B11 (surface on which no image is formed) side is displayed.

By displaying such an animation, even in the case where the second sheet image is displayed, the actual external appearance of a sheet which is placed on the placement section 321 is obtained. An animation to be displayed is not limited to the above. For example, the sheet image display controller 404 may cause, in the example of FIGS. 14A to 14C, an animation in which an image changes from the sheet image C12 into a sheet image representing the external appearance of a sheet in which the image G11 is upside down (that is, a sheet corresponding to the sheet P12 illustrated in FIG. 14A) to be displayed, or may cause in the example of FIGS. 16A and 16B, an animation in which an image changes from the sheet image C14 into a sheet image representing the external appearance of a sheet in which the upper part of the image G11 is directed to the left side of the display surface 471 (that is, a sheet corresponding to the sheet P14 illustrated in FIG. 16A) to be displayed.

Furthermore, the number of images representing an animation may be greater or smaller than the example of FIGS. 18A to 18F as long as the images representing the animation include at least a second sheet image (in the example of FIGS. 18A to 18F, the sheet image C12) and an image representing the external appearance of the sheet represented by the second sheet image obtained when the sheet is viewed from the first direction (in the example of FIGS. 18A to 18F, the image C125).

### [3-4] Sheet Image

A sheet image is an image which represents the external appearance of a sheet. The sheet image may be a photographic image which realistically represents the external appearance, or may be an image obtained by deforming the external appearance. For example, individual characters included in an image of text may not been expressed by a sheet image. Therefore, text may be expressed by line segments for individual rows. In such a case, it is desirable that the image is close to the external appearance of the actual sheet so that a user may understand the image that is formed on the sheet.

### [3-5] Timing of Displaying Sheet Image

In an exemplary embodiment, the sheet image display controller 404 starts to display a sheet image at a timing at which an image is formed on a sheet, and causes the sheet image to be displayed superimposed on another sheet image at a timing at which the sheet is transported. However, the timing is not limited to the above. For example, display of a sheet image may be started at a timing at which a sheet is transported, or display of a sheet image may be started before the image is formed on the sheet. Furthermore, display of a sheet image may be started after a predetermined time has passed since transportation of the sheet. A sheet image may be displayed superimposed on another sheet image from the beginning as illustrated in FIG. 7B, without moving the sheet image as illustrated in FIGS. 7A and 7B.

### [3-6] Display Target and Period for Sheet Image

The sheet image display controller 404 may cause a sheet image for all the images to be formed on a sheet to be displayed or may cause a sheet image for some images to be displayed. For example, in the case where image formation is performed at high speed, displaying sheet images for all the images makes it difficult to confirm each sheet image. Therefore, it is desirable that the sheet image display controller 404 causes a sheet image to be displayed during a period necessary for a user to confirm an image, for example, by displaying a sheet image for one of five images.

### [3-7] Number of Sheet Images

In an exemplary embodiment, the sheet image display controller 404 causes two or three sheet images to be simultaneously displayed. However, the number of sheet images simultaneously displayed is not limited to the above. Only one sheet image may be displayed or four or more sheet images may be displayed at the same time. In the latter case, sheet images in which an image before being formed on a sheet, a formed image before being transported, and a transported image are arranged may be displayed in order so that the progress of a process of image formation for each image may be understood.

### [3-8] Cancellation of Image Formation

In the image forming system 1, if image formation is cancelled due to an error of the system or the like, a blank sheet may be transported without an image being formed. In such a case, the sheet image display controller 404 causes a sheet image which represents the external appearance of a sheet on which the last image is formed before the cancellations to be displayed. Accordingly, a user is able to understand the last image formed. Therefore, the user is able to easily perform an operation for starting from the point at which the image formation was stopped, compared with the case where a blank sheet image is displayed.

[3-9] Sheet on which Multiple Images are Formed

In the case where multiple images are formed on a single sheet, the sheet image display controller 404 causes a sheet image which represents the external appearance of the sheet to be displayed.

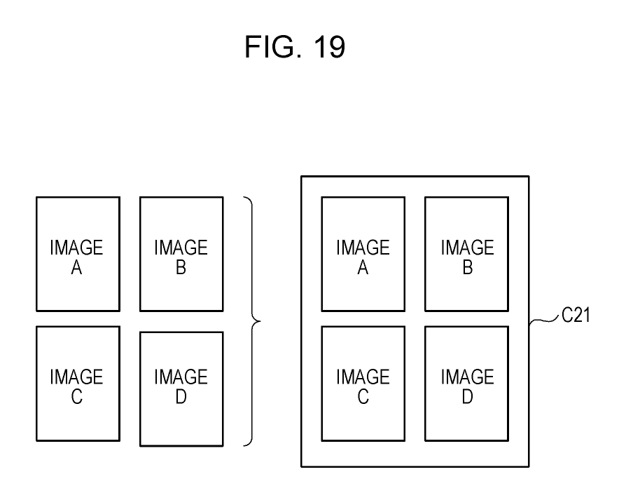

FIG. 19 illustrates an example of a sheet image according to a modification. In the example of FIG. 19, a sheet image C21 which represents the external appearance of a sheet on which four images: images A, B, C, and D, are formed is illustrated.

In this case, the sheet image display controller 404 may first cause a sheet image which represents the external appearance of four sheets in which individual images are formed to be displayed, and then cause an animation which represents image synthesis and transition to the sheet image C21 to be displayed.

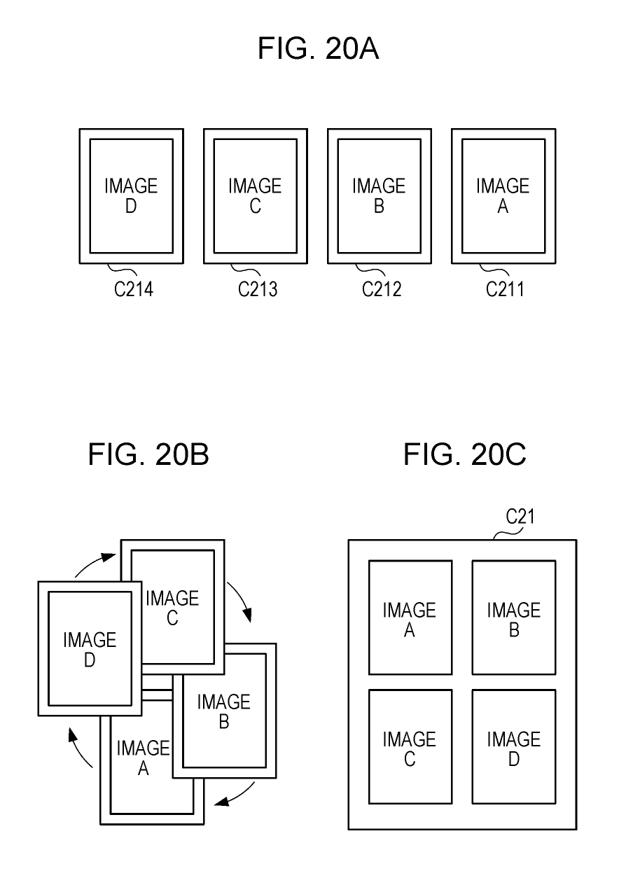

FIGS. 20A, 20B, and 20C illustrate an example of an animation according to a modification. The sheet image display controller 404 first, as illustrated in FIG. 20A, causes sheet images C211, C212, C213, and C214 on which images A, B, C, and D are formed to be displayed.

Next, the sheet image display controller 404 moves the sheet images such that the individual sheet images meet at a point while creating an arch, as illustrated in FIG. 20B, and after the movement is done for some extent, the sheet image C21 is reached, as illustrated in FIG. 20C. In this case, the size of each of the sheet images C211, C212, C213, and C214 may be equal to the size of the sheet image C21. Accordingly, compared with the case where the sheet image C21 is displayed from the beginning, individual images may be displayed in a larger size so that a user may confirm the contents. In addition, a state in which the images are formed on a sheet may be indicated.

### [3-10] Display of Characters

In the case where a sheet image which represents the external appearance of the front surface or the rear surface of a sheet is displayed, the sheet image display controller 404 may cause characters representing that the external appearance of the front surface or the rear surface of the sheet is displayed to be displayed.

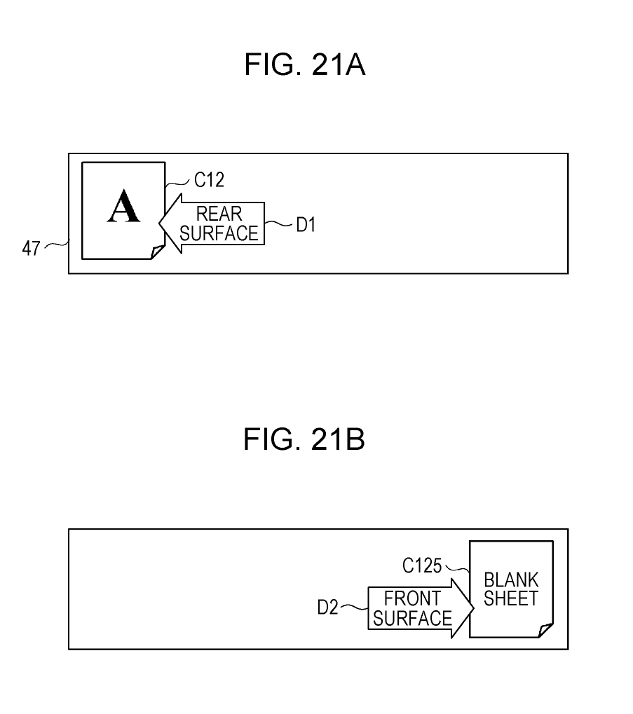

FIGS. 21A and 21B illustrate an example of a sheet image according to a modification. In FIG. 21A, the sheet image display controller 404 causes the sheet image C12 illustrated in FIG. 18A to be displayed on the UI unit 47 and causes a character image D1 which represents characters representing “rear surface” to be displayed.

In FIG. 21B, the sheet image display controller 404 causes the sheet image C125 illustrated in FIG. 18F to be displayed and causes a character image D2 which represents characters representing “front surface” to be displayed. By displaying such character images, the external appearance of which surface (front surface or rear surface) of a sheet that each sheet image represents may be indicated.

### [3-11] Image of Post-Processing

In the case where post-processing such as sorting and stapling is performed at the post-processing apparatus 30, the sheet image display controller 404 may cause an image (including a still image or a moving image) which represents execution of the post-processing to be displayed.

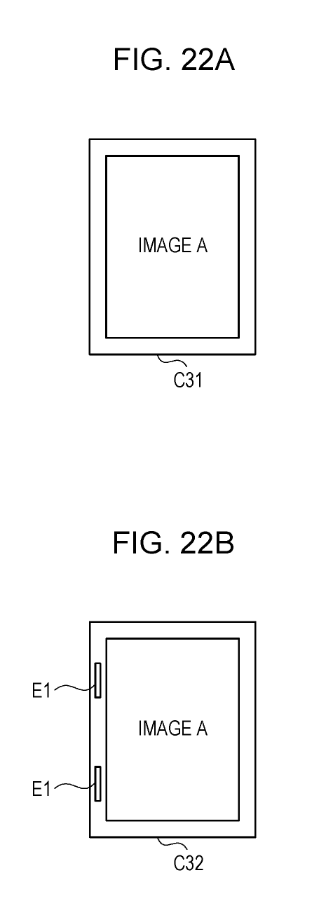

FIGS. 22A and 22B illustrate an example of a sheet image according to a modification. The sheet image display controller 404 first causes a sheet image C31 which represents the external appearance of a sheet on which an image A is formed as illustrated in FIG. 22A to be displayed, and then causes a sheet image C32 in which staple images E1 which represent stapling are superimposed on the sheet image C31 as illustrated in FIG. 22B to be displayed. Accordingly, post-processing performed on a sheet on which an image is formed is illustrated.

### [3-12] Apparatus Implementing Individual Functions

The individual units illustrated in FIG. 8 may be implemented by an apparatus other than the UI apparatus 40 (for example, a controller provided in the image forming apparatus 20, a client terminal which is connected to the image forming apparatus 20 via a communication line, or the like). In short, the individual units may be implemented by any information processing apparatus as long as it is able to perform operation of the individual units illustrated in FIG. 8 by processing information of the diameter of a roll sheet, an indication position, and the like.

### [3-13] Category of Invention

The present invention may be regarded as an information processing apparatus such as a UI terminal and an image forming system which includes the information processing apparatus. Furthermore, the present invention may also be regarded as a processing method for performing processing to be executed by a computer which controls the information processing apparatus and a program for causing the computer to function as the individual units illustrated in FIG. 8. The program is provided in the format of a recording medium such as an optical disk which stores the program, or in a format in which the program is downloaded and installed into the computer via a communication line such as the Internet to be usable.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires a direction of an image relative to a placement section, the image being formed on a sheet which is transported to and placed on the placement section; and
a display controller that performs control for displaying a first image on a display, the first image representing an external appearance obtained when the sheet which is placed on the placement section and on which the image is formed is viewed from a specific direction relative to the placement section, and causes, in a case where the direction which is predetermined for the image is acquired, a second image which represents an external appearance of the sheet obtained when viewed from a direction different from the predetermined direction to be displayed.

2. The information processing apparatus according to claim 1, wherein in a case where the image is formed on a single surface of the sheet and a direction in which the image faces the placement section is acquired by the acquisition unit, the display controller causes an image which represents an external appearance of the sheet obtained when viewed from the placement section to be displayed as the second image.

3. The information processing apparatus according to claim 1, wherein in a case where the image is formed on both surfaces of the sheet, the display controller causes the first image to be displayed with a direction in which the sheet is viewed from a side opposite the placement section being defined as the specific direction, and causes an image which represents an external appearance of the sheet obtained when viewed from the placement section not to be displayed.

4. The information processing apparatus according to claim 1,
wherein top and bottom of the image are defined,
wherein a front side and a back side of the placement section relative to a user are defined, and
wherein in a case where a top side of a display surface of the display is the back side, the first image is displayed with a direction in which a bottom side of the display surface is the front side being defined as the specific direction, and a direction in which an upper part of an image formed on the sheet is directed to the front side is acquired by the acquisition unit, the display controller causes an image which represents an external appearance of the sheet obtained when viewed from a direction in which the upper part is the top side of the display surface to be displayed as the second image.

5. The information processing apparatus according to claim 1,
wherein top and bottom of the image are defined,
wherein a front side and a back side of the placement section relative to a user are defined, and
wherein in a case where a top side of a display surface of the display is the back side, the first image is displayed with a direction in which a bottom side of the display surface is the front side being defined as the specific direction, and a direction in which an upper part of the image is directed to an upstream side of a transport direction in which the sheet is transported to the placement section is acquired by the acquisition unit, the display controller causes an image which represents an external appearance of the sheet obtained when viewed from a direction in which the upper part is the top side of the display surface or a direction in which the top side is the front side to be displayed as the second image.

6. The information processing apparatus according to claim 1, wherein in a case where the second image is displayed, the display controller causes an animation in which an image changes from an external appearance of the sheet represented by the second image into an external appearance of the sheet represented by the first image.

7. An information processing method comprising:
acquiring a direction of an image relative to a placement section, the image being formed on a sheet which is transported to and placed on the placement section; and
performing control for displaying a first image on a display, the first image representing an external appearance obtained when the sheet which is placed on the placement section and on which the image is formed is viewed from a specific direction relative to the placement section, and causing, in a case where the direction which is predetermined for the image is acquired, a second image which represents an external appearance of the sheet obtained when viewed from a direction different from the predetermined direction to be displayed.

8. A non-transitory computer readable medium storing a program causing a computer to execute a process for information, the process comprising:
acquiring a direction of an image relative to a placement section, the image being formed on a sheet which is transported to and placed on the placement section; and
performing control for displaying a first image on a display, the first image representing an external appearance obtained when the sheet which is placed on the placement section and on which the image is formed is viewed from a specific direction relative to the placement section, and causing, in a case where the direction which is predetermined for the image is acquired, a second image which represents an external appearance of the sheet obtained when viewed from a direction different from the predetermined direction to be displayed.
